(19) United States
(12) Patent Application Publication
(10) Pub. No.: US 2013/0047728 A1
(43) Pub. Date: Feb. 28, 2013

(54) APPARATUS AND METHOD FOR THE MANIPULATION OF OBJECTS USING ULTRASOUND

(71) Applicants: Sandy Cochran, Dundee (GB); Bruce Drinkwater, Bristol (GB); Martyn Hill, Southampton (GB); David Cumming, Glasgow (GB)

(72) Inventors: Sandy Cochran, Dundee (GB); Bruce Drinkwater, Bristol (GB); Martyn Hill, Southampton (GB); David Cumming, Glasgow (GB)

(73) Assignees: UNIVERSITY OF DUNDEE, Dundee (GB); UNIVERSITY OF SOUTHAMPTON, Southampton (GB); UNIVERSITY OF GLASGOW, Glasgow (GB); UNIVERSITY OF BRISTOL, Bristol (GB)

(21) Appl. No.: 13/497,198

(22) PCT Filed: Sep. 21, 2010
(86) PCT No.: PCT/GB2010/001774

§ 371 Date: Oct. 31, 2012

(30) Foreign Application Priority Data
Sep. 21, 2009 (GB) 0916437.7
Jul. 30, 2010 (GB) 1012855.1

(51) Int. Cl. G01H 17/00

(52) U.S. Cl. 73/570.5

(57) ABSTRACT

A method and apparatus for manipulating particles. The apparatus comprising an ultrasound source for providing a variable ultrasound signal within a region of interest, and a controller connected to the ultrasound source such that it provides a control signal to the ultrasound source. The variable ultrasound signal creates a pressure field within the region of interest, the shape and/or position of which can be altered by changing the control signal input to the ultrasound source such that a particle within the region of interest will move in response to changes in the pressure field.

The present invention relates to an apparatus and method for the manipulation of objects such as particles, powders, biomolecules, biological cells, cell bundles and fluids.

### BACKGROUND TO THE INVENTION

Movement of particles with dimensions from below 1 μm to over 100 μm such as biomolecules, cells, and cell bundles is increasingly important in the life sciences, engineering, and medicine. In the life sciences, the ability to hold and manipulate cells and biomolecules using technologies such as dielectrophoresis (DEP) and optical tweezers has led to significant advances in areas including biological and chemical analysis, separation and sorting of cells, investigation of cell characteristics, measurements of forces, and tissue engineering.

Existing devices have very valuable capabilities for which they are already utilised widely but also limitations in terms of forces that can be produced and measured, particle sizes that can be handled, their range of compatible buffer characteristics, sensitivity to heating, and suitability for integration with sensors in low cost devices.

The use of ultrasound to hold bioparticles in a position has been shown to work in principle. In one example, piezoelectric transducer plates produce single or multiple resonances in order to hold particles in position.

In another example, particle manipulation can be achieved by using acoustical tweezers. These operate by trapping particles in ultrasonic standing wave fields between the plates of devices which resemble tweezers. The particles are moved by physically moving the tweezers but this arrangement does not allow the particles to be moved independently of the tweezer device.

The use of ultrasound to exert radiation forces on small particles has already been made in novel filtration devices. These generate resonances between plate-like piezoelectric transducers in which lines of zero or low pressure (nodal lines) are created. The forces on the particles are governed by the local energy gradients which are maximised in the standing wave fields found in such devices. Bioparticles, eukaryotic cells and bacteria in the size range 1 μm and above, have been made to migrate to the pressure nodes between plate-like piezoelectric elements. Accumulation of particles at the nodes in the fluid allowed these systems to be used as filters.

Whilst the use of ultrasound standing waves as a filtration device is known, the flexibility of this technique is limited by the small number of standing wave patterns that can be established because the operating frequency of the device is a function of the chamber geometry.

### SUMMARY OF THE INVENTION

In accordance with a first aspect of the present invention there is provided apparatus for manipulating particles, the apparatus comprising: an ultrasound source for providing a variable ultrasound signal within a region of interest; a controller connected to the ultrasound source such that it provides a control signal to the ultrasound source, wherein the variable ultrasound signal creates a pressure field within the region of interest, the shape and/or position of which can be altered by changing the control signal input to the ultrasound source such that a particle within the region of interest will move in response to changes in the pressure field.

The control signal advantageously changes the phase of the ultrasound signal from the ultrasound source to thereby alter the shape and/or position of pressure field.

The ultrasound source advantageously comprises a multi-element ultrasonic array.

The control signal advantageously implements electronic phasing of the multi-element array outputs.

The multi-element ultrasonic array advantageously comprises a plurality of transducers which are acoustically matched.

Matching of the transducers to the region of interest allows fine control of the transducer boundary conditions leading to fine control of the pressure field and hence of the particles themselves.

The multi-element approach enables manipulation of single particles and in small groups with fine positional control. The particle(s) will them be moved in the region of interest by controlling the pressure field.

Additionally or alternatively, the multi-element ultrasonic array comprises a plurality of transducers which are acoustically damped.

The multi-element array advantageously comprises particle levitation means operable to control movement of a particle in a substantially levitated state and particle manipulation means, operable to manipulate movement of a particle.

The particle manipulation means is advantageously operable to control the movement of a said particle in a substantially lateral direction.

The particle levitation means preferably comprises a piezoceramic plate and a reflection plate separated therefrom.

The particle manipulation means preferably comprises a pair of matched piezoelectric transducers separated from each other and disposed so as to face each other.

Preferably, the pair of piezoelectric transducers, the piezoceramic plate and the reflection plate are arranged relative to each other so as to form a cavity wherein the boundaries of the cavity are provided by the piezoelectric transducers, the piezoceramic plate and the reflection plate.

The cavity preferably comprises a fluid and more preferably comprises water.

Accordingly, the apparatus may comprise a plurality of matched piezoelectric transducers arranged to provide two-dimensional or three-dimensional control of a said particle.

Where a plurality of particles are present, at least one of said particles may be moveable independently of the others.

The control signal may change the amplitude of the ultrasound signal from the ultrasound source to thereby alter the shape and/or position of pressure field.

Additionally, or alternatively, the control signal may change the spectral frequency content of the ultrasound signal from the ultrasound source to thereby alter the shape and/or position of pressure field.

Accordingly, the present invention can manipulate particles without any moving parts, by adjusting the amplitude and/or phase and/or frequency of the signals generated by elements in the array.

The control signal preferably implements electronic amplitude changes of the multi-element array outputs.

The multi-element ultrasonic array preferably comprises a plurality of transducers which are electrically matched.

The pressure field is advantageously provided by a pulsed ultrasound signal. The pressure field may be switched on and off by means of the pulsed ultrasound signal.

This approach may give greater control and may stop the build-up of ultrasonic streaming effects that may make control problematic.

These effects provide a ‘ratcheting’ mechanism by which the pulsed signal provides an incremental change to move a particle to a new position.

The controller may comprise computing means and an electronic signal generator. The computing means may be provided with a computer program which operates an electronic controller for controlling the ultrasound source.

In accordance with a second aspect of the invention there is provided a method comprising the steps of: providing an ultrasound source operable to provide a variable ultrasound signal within a region of interest; providing a control signal to the ultrasound source, wherein the variable ultrasound signal creates a pressure field within the region of interest, controlling the control signal input to thereby control the shape and/or position of the pressure field such that a particle within the region of interest is controllable.

Controlling the control signal advantageously comprises causing a change in the phase of the ultrasound signal to cause a change in the pressure field in order to move one or more particle around the region of interest in a controlled manner.

The ultrasound source advantageously comprises a multi-element ultrasonic array.

The control signal advantageously implements electronic phasing of the multi-element array outputs.

The multi-element ultrasonic array advantageously comprises a plurality of transducers which are acoustically matched.

Matching of the transducers to the region of interest allows fine control of the transducer boundary conditions leading to fine control of the pressure field and hence of the particles themselves.

The multi-element array preferably comprises between 100-200 elements/wavelength.

The multi element approach allows manipulation of single particles and in small groups with fine positional control. The particle may be moved in the region of interest by controlling the pressure field.

The present invention can manipulate particles without any moving parts, by adjusting the amplitude and/or phase of the signals generated by elements in the array.

Additionally, or alternatively, the multi-element ultrasonic array comprises a plurality of transducers which are acoustically damped.

The multi-element array advantageously comprises particle levitation means operable to control movement of a particle in a substantially levitated state, and particle manipulation means, operable to manipulate movement of a particle, and the method further comprises actuating the particle levitation means to at least substantially levitate a particle, and actuating the particle manipulation means to manipulate the movement of a said particle.

The particle manipulation means is advantageously operable to manipulate the movement of the said particle in a substantially lateral direction.

The particle levitation means preferably comprises a piezoceramic plate and a reflection plate separated therefrom.

The particle manipulation means preferably comprises a pair of matched piezoelectric transducers separated from each other and disposed so as to face each other.

The pair of piezoelectric transducers, the piezoceramic plate and the reflection plate are preferably arranged relative to each other so as to form a cavity wherein the boundaries of the cavity are provided by the piezoelectric transducers, the piezoceramic plate and the reflection plate.

The cavity is preferably at least partially filled with a fluid, and more preferably water.

The ultrasound source advantageously comprises a plurality of matched piezoelectric transducers arranged to provide two-dimensional or three-dimensional control of a said particle.

Where a plurality of particles are present, at least one of said particles may be moveable independently of the others.

Controlling the control signal advantageously causes a change in the amplitude of the ultrasound signal from the ultrasound source to thereby alter the shape and/or position of pressure field.

Additionally, or alternatively, controlling the control signal may cause a change in the spectral frequency of the ultrasound signal from the ultrasound source to thereby alter the shape and/or position of pressure field.

The control signal advantageously implements electronic amplitude changes of the multi-element array outputs.

The multi-element ultrasonic array advantageously comprises a plurality of transducers which are operable to be electrically matched.

The pressure field is advantageously switched on and off by means of a pulsed ultrasound signal.

This approach provides greater control and can at least substantially mitigate the build-up of ultrasonic streaming effects that can make control problematic.

These effects provide a ‘ratcheting’ mechanism in which the pulsed signal provides an incremental change to move a particle to a new position.

In accordance with a third aspect of the invention there is provided a computer program comprising program instructions for carrying out the method of the second aspect of the invention.

In accordance with a fourth aspect of the invention there is provided a controller for controlling the movement of particles, the controller being connectable to an ultrasound source to provide a variable ultrasound signal for creating a pressure field within a region of interest, and operable to control the ultrasound signal and thereby control the shape and/or position of the pressure field such that the movement of a particle within the region of interest is controlled.

The control signal advantageously changes the phase of the ultrasound signal.

Additionally, or alternatively, the control signal may change the amplitude of the ultrasound signal.

Additionally, or alternatively, the control signal may change the spectral frequency content of the ultrasound signal.

The controller may be adapted for use with an ultrasound source comprising a multi element ultrasonic array.

The control signal advantageously implements electronic phasing of the multi-element array outputs.

The control signal advantageously implements electronic amplitude changes of the multi-element array outputs.

The controller is advantageously operable to provide a pulsed ultrasound signal.

The controller preferably comprises computing means and an electronic signal generator wherein the computing means is provided with a computer program which operates an electronic controller for controlling the ultrasound source.

In accordance with a fifth aspect of the invention there is provided a micro-fluidic device comprising one or more fluid pathways wherein the device further comprises fluid manipulation means for moving a fluid along fluid pathways in the micro-fluidic device, the manipulation means comprising an ultrasound source for providing a variable ultrasound signal within the micro-fluidic device; a controller connected to the ultrasound source such that it provides a control signal to the ultrasound source, wherein the variable ultrasound signal creates a pressure field within the micro-fluidic device, the shape and/or position of which can be altered by changing the control signal input to the ultrasound source such that a fluid within the micro-fluidic device will move in response to changes in the pressure field.

The micro-fluidic device advantageously comprises one or more fluid analysis locations.

The controller advantageously provides a control signal which causes the ultrasound source to create a predetermined pressure field in the region of interest.

The control signal can advantageously be altered to change the predetermined pressure field distribution in order to move one or more particle around the region of interest in a controlled manner.

The control signal advantageously changes the phase of the ultrasound signal from the ultrasound source.

Additionally, or alternatively, the control signal may change the amplitude of the ultrasound signal from the ultrasound source.

Additionally, or alternatively, the control signal may change the spectral frequency content of the ultrasound signal from the ultrasound source.

The ultrasound source is advantageously a multi element ultrasonic array.

The control signal advantageously implements electronic phasing of the multi-element array outputs.

The control signal advantageously implements electronic amplitude changes of the multi-element array outputs.

The multi-element ultrasonic array advantageously comprises a plurality of transducers which are acoustically matched.

Matching of the transducers to the region of interest allows fine control of the transducer boundary conditions leading to fine control of the pressure field and hence of the particles themselves.

The multi element approach will allow manipulation of single particles and in small groups with fine positional control. The particle(s) will them be moved in the chamber by changing the pressure minimum or the flow.

The present invention can manipulate particles without any moving parts, by adjusting the amplitude and/or phase of the signals generated by elements in the array.

Optionally, the pressure field may be provided by a pulsed ultrasound signal.

These effects provide a ‘ratcheting’ mechanism in which the pulsed signal provides an incremental change to move a particle to a new position.

The present invention provides for the creation of configurable pressure fields which are designed to move one or more particles between predetermined positions in the region of interest.

This allows a single ultrasound source to be used for a number of different types of particle manipulation.

The present invention provides controlled ultrasonic signals which produce and dynamically modify the pressure field, hence allowing flexibility in control of particles in the region of interest.

The action of a pressure field on a particle results in a “force potential landscape” and this term refers to the relationship between sets of points in the region of interest where the force experienced by an identical particle at any point in the set is the same. Each set of points can be expressed graphically as a line connecting the points. The forces exerted on a particle are dependent upon the pressure field and a number of physical properties of the particles including but not limited to particle and fluid acoustic impedance, density and viscosity as well as particle size.

The particle may be any object including a fluid within the region which has a size, density or mass that allows the object to be moveable by the force on the particle as described by the force potential landscape created by the pressure field.

### BRIEF DESCRIPTION OF THE DRAWINGS

The present invention will now be described by way of example only with reference to the accompanying drawings in which:

FIG. 1 illustrates schematically, the features of one embodiment of the present invention;

FIG. 2 illustrates schematically, the features of another embodiment of the present invention;

FIG. 3 illustrates schematically, the features of another embodiment of the present invention

FIG. 4 shows an ultrasound array used in one or more embodiment of the present invention;

FIG. 5 shows another example of an ultrasound array used in one or more embodiment of the present invention;

FIGS. 6a to 6e show the movement of a particle in a region of interest using a device in accordance with the present invention;

FIG. 7 shows an example of an ultrasonic/acoustic pressure field as created by an embodiment of the present invention;

FIG. 8 shows an example of a microfluidic device in accordance with the present invention;

FIG. 9 is a schematic drawing in section of an alternative embodiment of apparatus according to the present invention;

FIG. 10 is a schematic drawing of a transducer of the apparatus of FIG. 9;

FIGS. 11a and 11b are images showing displacement of particles using the apparatus of FIG. 9; and

FIG. 12 is a graph showing displacement of particles as a function of relative phase, ΔΦ, for the apparatus of FIG. 9.

### DETAILED DESCRIPTION OF THE DRAWINGS

The present invention controls pressure created by ultrasound waves in a region of interest in order to manipulate particles, the forces being dependent upon the physical characteristics of the particles and fluid. The sensors are driven to generate a predetermined pressure distribution. This generates a predetermined force potential landscape for the particle in the region of interest, which is dynamic in nature because changes in the ultrasound input to the region of interest change the pressure distribution and therefore the force potential landscape.

In such landscapes, particles move with a force determined by the gradient of the force potential landscape and the characteristics of the particles. The force potential landscape is variable and can, for example, be a single or multiple stable potential well. Sorting and other practical functions are then achieved by relying on the varying responses of particles with different properties to the potential, or through the combined effects of the ultrasonic landscape and an external driving force such as the viscous drag of a microfluidic flow.

The following description of the force potential landscape created by an ultrasonic/acoustic pressure field which acts on a particle of a given size in a region of interest is provided.

The force vector, [symbol] , is obtained from the scalar potential function, U by [symbol] =−∇U

Where ∇ is the grad operator defined by

$$∇ = \frac{\partial U}{\partial x} + \frac{\partial U}{\partial y} + \frac{\partial U}{\partial z}$$

and x, y and z are a system of Cartesian axes.

Also, though various techniques are available in the literature the work of Gor'kov (Gor'kov, L. P., 1962, On the forces acting on a small particle in an acoustical field in an ideal fluid, Soviet Physics—Doklady, 6(9), pp. 773-775.) shows that the scalar potential function can be obtained from

$$U = 2 {πρ}_{0} {a}^{3} \{ \frac{{\overline{p}}_{in}^{2}}{2 {ρ}_{0}^{2} {c}_{1}^{2}} {f}_{1} - \frac{{\overline{\dot{u}}}_{in}^{2}}{2} {f}_{2} \}$$

Where f₁=1−c₀²ρ₀/c₁²ρ₁ and f₂=2(ρ₁−ρ₀)/(2ρ₁+ρ₀)

Additionally, p̅ᵢₙ² and [symbol] are the mean-squared incident pressure and particle velocity fields respectively, a is particle radius, ρ is density and c speed of sound, subscripts 0 and 1 referring to the fluid and particle respectively.

The present invention can produce a wider variation of force potential features over a larger area than dielectrophoresis or optical tweezers for example.

This will enable applications such as, for example manipulation of larger particles or particle clusters, for which optical trapping is less suitable, and will in turn create new opportunities in areas such as high-throughput screening. In addition, larger forces can be used which allows the manipulation of larger particles.

The apparatus of the present invention can also manipulate large arrays of particles. However, unlike DEP tweezers, the present invention does not require high electric fields, is not complicated by buffer effects and additional unwanted forces such as electrokinetic flow.

The forces generated and area of action of a device in accordance with the present invention should far exceed those applied by optical tweezers. However, because the wavelength of light (˜630 nm for red light) is typically smaller than of ultrasound (10-1500 μm for 100-10 MHz frequencies) optical tweezers can operate with smaller particles.

FIG. 1 shows a first embodiment 1 of the present invention which comprises a computer 3, an electronic signal generator/controller 5 and an ultrasound source 7 within which is located the region of interest where the particles are manipulated. In this embodiment of the invention, the computer 3 runs a computer program which determines the type of control signal that is provided to the ultrasound source by the signal generator/controller 5. The computer program can provide a sequence or routine of instructions which creates signals in the signal generator/controller 5 to vary the ultrasound signal created by the ultrasound source which in turn creates an pressure field that then, in the presence of a particle, leads to a force potential landscape within the region of interest.

Variations in the shape and/or position of the pressure field are made by changing the control signal input to the ultrasound source.

The computer program on the computing means 3 can be set to create predetermined changes in the force potential landscape in order to make particles in the region of interest move from a first to a second position in a reproducible manner. The present invention may also allow the computing means to be programmed such that manipulation of a particle can be controlled manually using an appropriate user interface.

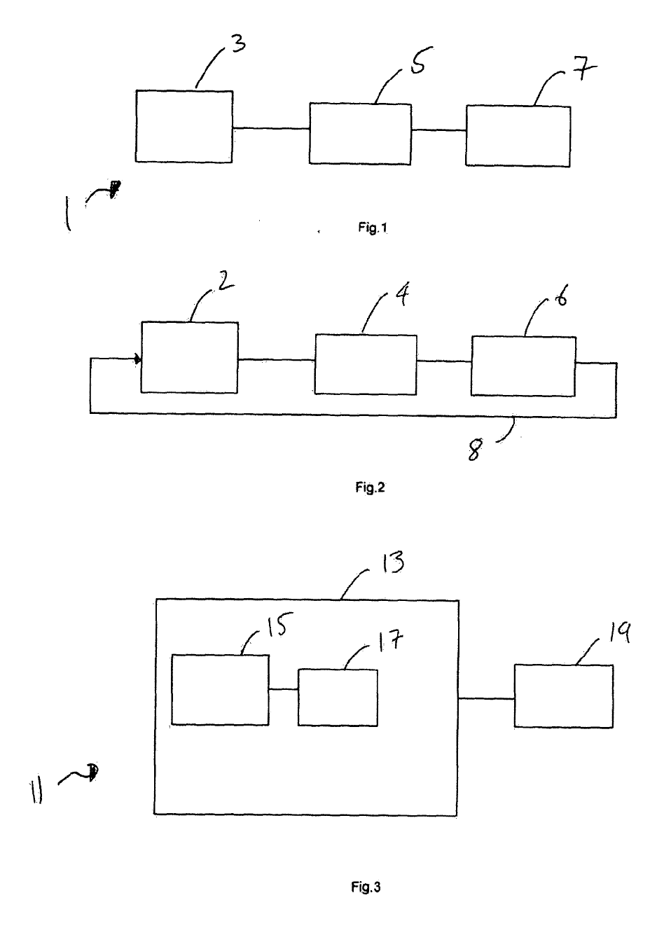

FIG. 2 shows a second embodiment of the present invention similar to that of FIG. 1 and comprising comprises a computer 2, an electronic signal generator/controller 4 and an ultrasound source 6 within which is located the region of interest where the particles are manipulated.

This embodiment also has a feedback loop 8 which allows the computer to alter the instructions for providing the control signal in response to the actual conditions in the region of interest of ultrasound source 6.

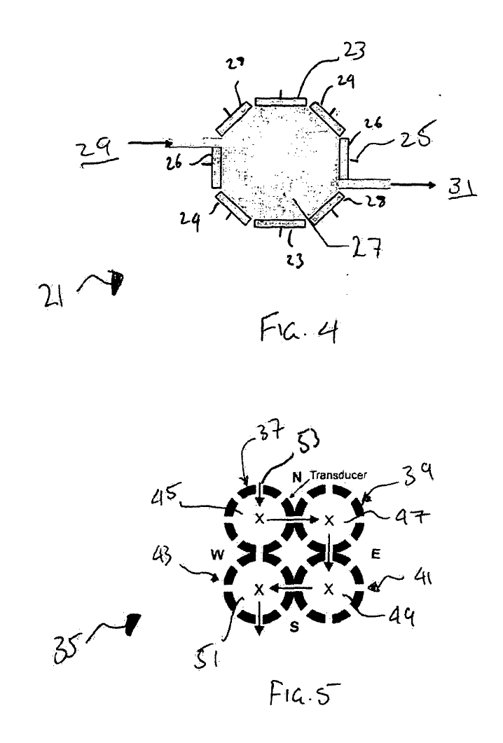

FIG. 3 shows a second embodiment of the present invention in which the device 11 comprises an integrated controller 13 which contains computing means 15 and a signal generator/controller 17 connected to an ultrasound source 19. This embodiment of the present invention functions in a similar manner to the embodiment of FIG. 1, the main difference being that control of the ultrasound device is provided in an integrated system which contains the computing means and signal generation means in a single box. The embodiment of FIG. 1 requires the use of external computing means such as a personal computer.

In order to design the computer programs to operate the device, pressure fields have been computed which form the input to force potential landscape and particle motion models. Once the driving force and other forces such as buoyancy, drag (hydrodynamic regime), gravity, and particle-particle and particle-boundary forces have been determined, the motion of the particles may be determined.

The present invention may allow the user to specify the desired particle behaviour and the mathematical model calculates the required transducer driving phases and amplitudes. As problems of complex standing wave pressure fields are not always amenable to analytical approaches, the inverse model may be
1. A full inverse model from numerical optimisation.
2. Simple rules derived from the full inverse model
3. A look-up table approach where the results of a range of forward models are stored for later use.

Such a numerical iteration will commence with a selected set of initial conditions then iteratively change the transducer driving functions to minimise the error between the current predicted pressure field and the desired field. This multi-dimensional optimisation problem may use a technique such as simulated annealing; from this process the interaction between the excitation and the resultant field will be characterised as an initial step in the development of practical design rules to control the ultrasonic fields in real time.

FIG. 4 illustrates an ultrasound source for use in a device in accordance with the present invention. In this example, the in-plane ultrasound source is a multi-element array 21 which comprises 4 pairs of array elements 23, 24, 26, 28 surrounding a centimetre-scale chamber. The four pairs of array elements 23, 24, 26, 28 are used to create an pressure distribution and hence a force potential landscape. The chamber is designed so that at zero phase shift the deepest potential trough is at the centre. Particles can be swept into this by phase modulation of pairs of transducers then held there or moved around by phasing the array elements.

Fluids and, if needed, nanoparticles such as genetic material or nanotoxicants can flow through the chamber while the particles remain trapped. Fresh particles can be allowed to flow into the chamber, be trapped in other minima, and be brought into contact with the initial particles by pressure field manipulation.

In this example, out-of-plane field of the chamber is a half wavelength deep (although any through thickness resonance could be used) at a predetermined operating frequency or will have an axial field maintained by an in-plane transducer located on the lower surface to ensure particles remain in the same plane throughout the process, with the chamber behaving as 2-D. The top surface, and in some cases both surfaces, will be transparent to facilitate observation of the particles.

Certain parameters of the design can be varied, these include array size, the number, size and distribution of the array elements, the frequency, and acoustic pressure amplitudes in fluids with different viscosities and the chamber depth and means of particle levitation.

The transducers can be integrated into a chamber which defines the region of interest by utilising curved piezocomposite geometries augmented by passive matching layers and appropriate areas of acoustic absorber as the chamber walls.

Miniature piezoelectric device fabrication techniques can be used to integrate the piezoelectric elements in the configurations needed with a silicon substrate, decoupled acoustically from the array, and an optically-accessible lid for observation of particle movement and integration with optical tweezing.

FIG. 5 shows another embodiment of the present invention in which the ultrasound source 35 comprises a group of multi-element arrays 37, 39, 41 and 43 having a planar structure. Each array has a region of interest (ROI) 45, 47, 49 and 51 and the particle/fluid path through the arrays is denoted by the arrow 53. In the presence of an overall flow, the application of ultrasound allows the particles to move freely through the system or be selectively held in a position, for example, over a sensor, to permit measurement of some property of the particle.

In FIG. 5 a particle enters ROI 45 of array 37 and can be held in place in the ROI or guided through ROIs 47, 49 and 51 of arrays 39, 41 and 43 under electronic control of the ultrasound fields.

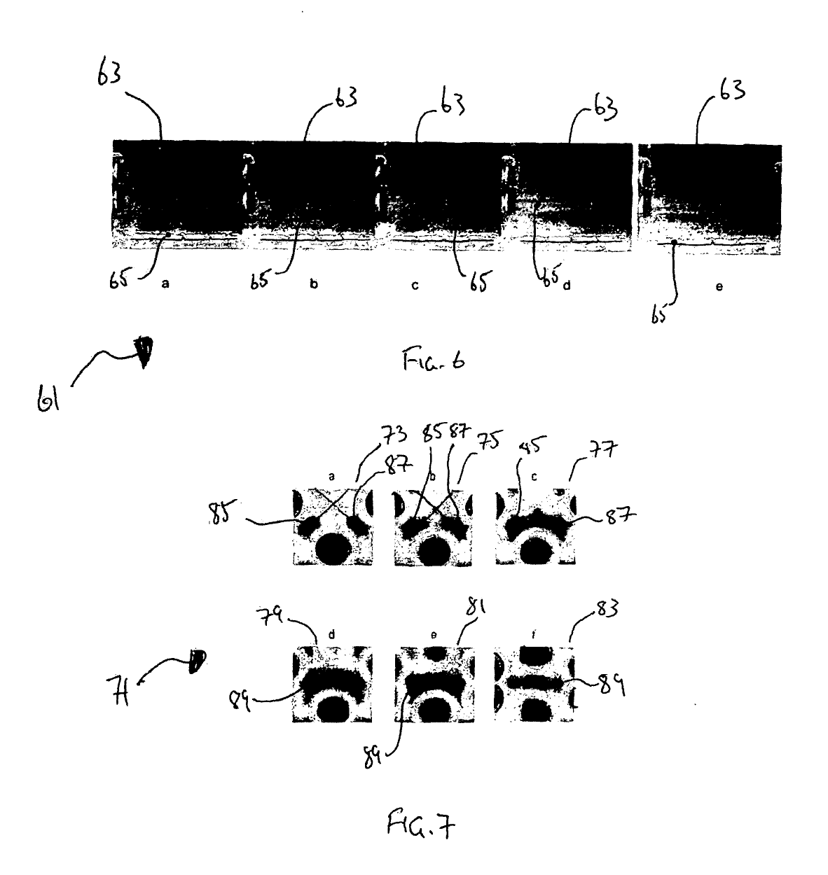

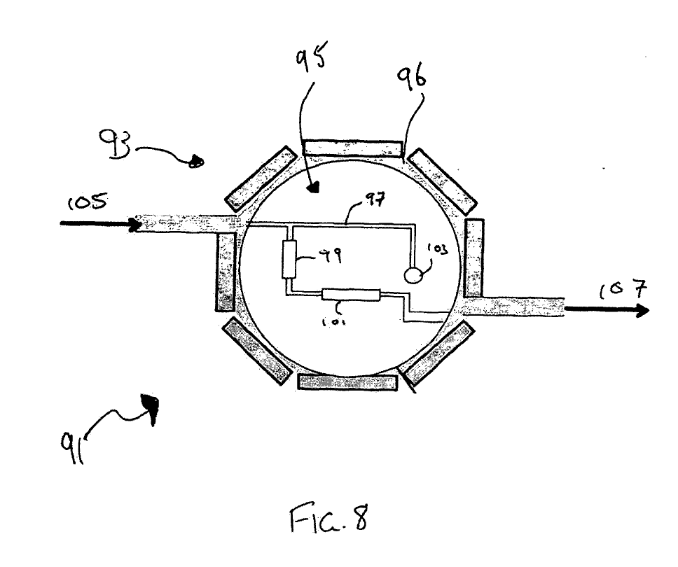

FIGS. 6a to 6e illustrate the movement of a particle 65 in a region of interest (chamber) 63 controlled by an apparatus in accordance with the present invention. The apparatus comprises a piezoelectric transducer array (not shown) which controls various 100 μm diameter glass particles in a 10×5 cm chamber 63 filled with vegetable oil.

FIG. 6a shows the resting position of the particle 65 in the chamber 63. The ultrasound array (not shown) may either be switched off or be switched on with the particle 65 positioned in a local potential energy minima. FIG. 6b shows movement of the particle 65 when the ultrasound is either switched on or the pressure gradient is altered such that the particle 65 moves to a second position. Further movement of the particle 65 to the right is shown in FIG. 6c, movement of the particle 65 to the left is shown in FIG. 5d and FIG. 5e shows the particle 65 being brought to its resting position.

The present invention provides a very versatile manipulation system that can be used to trap particles, to move them to a given location, to bring particles or groups of particles together, and to sort them by size or acoustic impedance depending upon the ultrasound field design.

This is demonstrated by the sequence of pressure fields illustration in FIGS. 7a to 7f. FIGS. 7 a to f 73, 75, 77, 79, 81 and 83 respectively show two pressure minima 85, 87 which have been generated by four transducer pairs, the pressure minima being positioned at different spatial locations in a region of interest (FIG. 7a). The pressure minima could contain different cell agglomerates, for instance. By phase and amplitude modulation of the signal applied to one or more pair of transducers, these minima, and thus the particles they contain, can be brought together as shown in FIGS. 7b to 7f.

FIG. 8 shows another embodiment of the present invention in which the ultrasound particle manipulation device is integrated with a microfluidic or “lab on a chip” device. One of the key advantages of this lab-on-a-chip approach is that it speeds up diffusion-limited processes. Conversely, the absence of fluid mixing in low Reynold's number systems makes it difficult to improve the speed of operation. The present invention combines the manipulation of particles using ultrasound with microfluidics/lab on a chip devices to generate specially designed potential landscape on the device.

FIG. 8 shows one configuration of such a device wherein the device 91 comprises a multi element array 93 with a microfluidic/lab on a chip device 95 positioned within the region of interest 96. The microfluidic device 95 comprises a number of microfluidic channels 97 which connect reaction areas 99, 101, and 103. The reaction areas may be for any suitable reaction such as PCR (polymerase chain reaction) or electrophoresis.

The multi-element array can create and selectively change pressure gradients on the microfluidic device to move fluids and other particles around the microfluidic device to enhance mixing via acoustic streaming and hence mass transfer and reaction rate in microfluidic channels. In other embodiments, the ultrasound can be used to transfer fluids around the microfluidic device and hence, eliminate or reduce the need for fixed microfluidic channels.

The present invention allows the user to specify the desired particle behaviour/movement and the computer program operating the controller provides the required ultrasound source driving phases and amplitudes.

In one example of the present invention a system which combines optical and ultrasound can be used to increase the range of applications for the technology.

In one example of the present invention, multielement arrays are used to create force potential landscapes to manipulate particles individually and in groups with fine positional control.

For example, to hold a particle in a given position, a local pressure field minimum generated by an array will form a potential well. The particle may then be manipulated by creating an ultrasonic pressure distribution which, in effect, moves the pressure field minimum through the use of appropriate ultrasonic array excitation signals or with flow through the chamber.

The present invention may be integrated into a silicon device by wafer bonding the piezoelectric ultrasound transducer materials and integrating them with electronics to create a new generation of silicon-based sensing devices. The sensor may be directly integrated onto silicon. These can be membrane based electrochemical sensors, usually embodied as ion-sensitive field effect transistors (ISFETS) or light addressable potentiometric sensors (LAPS); and Clark cell based devices.

In another embodiment of the invention, particles can be controlled by the use of transient effects that occur for short periods, for example, pulse excitation of the transducers.

The present invention may be used in the analysis of biological and chemical species on a microfluidic scale. This offers several benefits over larger scales, including very short reaction times and the need for only very small samples. Micromanipulation allows cells to be moved to specific biosensing sites and here will be applied to the development of bio-hazard detection methods.

The present invention may also be used in the sorting of cells into different populations based on measurable characteristics. The existence of well-characterised potential gradients will allow cells to be separated using competing force fields (such as viscous drag) to fractionate on the basis of characteristics such as cell size and acoustic properties. This will be applied to mixtures of fibroblasts and smooth muscle cells and to neural stem cell cultures.

The present invention will allow groups of cells to be brought together to interact in the absence of a substrate thus providing an in vitro platform to study cell interactions, differentiation and tissue development applicable to the study of medical conditions, cancer development and treatment, regenerative medicine and tissue engineering. In vivo, the structural cells that line the bronchi form themselves into a lamellar structure with the cells in different layers performing distinct functions. Such a structure is extremely difficult to reproduce outside the body and this is a significant limitation on the in vitro studies required to understand cell-cell interactions in conditions such as asthma and COPD. The present invention may be adapted to allow the growth of levitated layers of cells that can be brought together into multilayer structures once each individual cell layer has consolidated.

Referring to FIG. 9, a preferred embodiment of the apparatus 200, according to the present invention, comprises a levitation stage 202, a manipulation stage 204 and a reflector plate 206.

The levitation stage 202, manipulation stage 204 and reflector plate 206 are arranged relative to each other to form cavity 208. The cavity 208 comprises a fluid, preferably a liquid such as, for example, water.

The levitation stage 202 is a resonant system comprising a piezoceramic plate 210 separated from the reflector plate 206 by the cavity 208. The piezoelectric plate 210 may, for example, be approximately 5 mm thick and 15 mm×15 mm square. The distance between the facing surfaces of the piezoelectric plate 210 and the reflector plate 206 (i.e. the depth of the cavity) may be, for example, approximately 4 mm.

The levitation stage 202 is operable to hold particles under control in the y-direction.

The manipulation stage 204 comprises a pair of transducers, 212a and 212b, disposed to face each other and on the same plane relative to each other. Referring also to FIG. 10, each transducer, 212a and 212b, comprises a piezoceramic plate, 214a and 214b, a matching layer, 216a and 216b, and a backing layer, 218a and 218b.

The dimension of the piezoceramic plates, 214a and 214b, may be, for example, approximately 15 mm×2 mm and 1.33 mm mm thick.

The matching layers, 216a and 216b, comprise epoxy and are doped with, for example aluminium.

The backing layers, 218a and 218b, comprise epoxy and are doped with, for example, Tungsten.

In use, a standing wave is produced in the liquid-filled cavity 208 using counter propergating travelling waves with a controllable phase difference between them. The travelling waves are generated by the opposing piezoelectric transducers, 212a and 212b, at either end of the cavity. The transducers, 212a and 212b, are acoustically matched to the liquid to minimise reflections from the boundary of the device. If the field amplitude generated by each transducer is the same then a standing wave pattern is generated with nodes positioned at half-wavelength separations. The acoustic radiation force exerted by the plane standing wave acts to move the particles to the nodes of the pressure field. Assuming that there is negligible reflection from the transducer faces, the position of the nodes changes linearly with the relative phase, ΔΦ, between the excitation signals applied to the transducers.

A one-dimensional eletro-acoustic transmission line model was used to determine the thicknesses and acoustic properties of the layers. In particular, the impedance (Zₘ) of the matching layer 216 would ideally be related to the impedances of the transducer (Z_{T}) and the fluid (Z_{W}) (e.g. water), in the cavity 208, by the relationship Zₘ=(Z_{W}Z_{T})^{1/2}. The experimental results of Wang et al (IEEE Trans. Ultrason. Ferroelectr. Freq. Control 48(1), 78-84 (2001)) were used to select suitable epoxy dopant compositions to achieve the desired acoustic properties. The resultant Suitable epoxy dopant compositions were then selected from the prior art to achieve the desired acoustic properties. The resultant Zₘ is within 50% of this optimal value, however this provides sufficient matching. The thickness (in the x-direction) and material properties of the components are provided in the table below.

| | | | | Bulk Longitudinal |
|---|---|---|---|---|
| | | Thickness | Density | Sound |
| Component | Material | (mm) | (kg m⁻³) | Velocity(ms⁻¹) |
| Backing | Epoxy | 9 | 2520 | 1950 |
| layer | (7.5% W by | | | |
| | Vol.) | | | |
| Piezoelec- | Noliac | 1.33 | 7800 | 4500 |
| tric plate | NCE51 | | | |
| Matching | Epoxy (10% | 0.40 | 1320 | 2700 |
| layer | Al₂O₃ by | | | |
| | vol.) | | | |

In use, a minimum in the reflection at the faces of the transducers, 212a and 212b, occurs when the frequency is such that the thickness of each matching layer, 216a and 216b, is equal to ¾ of the wavelength within it, or alternatively equal to ¼ or 5/4 etc. Theoretically this can be calculated to occur at 5 MHz for the device herein described. However, in practise the best operation was found at 5.25 MHz. Each transducer, 212a and 212b, is excited using a separate sine-wave generator and an amplifier to apply a sinusoidal voltage of 35 Vₚ₋ₚ. The sine-wave generators are phase-locked to allow control of the phase difference ΔΦ. At this frequency a standing wave of wavelength λ=0.28 mm in the cavity liquid is produced. The acoustic pressure field can be imaged using a Schlieren imaging system in the absence of particles and with no excitation of the levitation stage 202. The imaging shows that the acoustic pressure field forms broadly uniform planes at least substantially perpendicular to the x-axis. By varying ΔΦ in the range 0≦ΔΦ≧2π the pressure field nodes can be moved one complete period in the x-direction (i.e. a distance of λ/2=0.139 mm). This is shown in the Schlieren images in FIG. 11a.

In use, with particles introduced into the fluid (e.g. water) in the cavity 208 and the levitation stage excited with a sinusoidal signal of, for example, 5 MHz and an amplitude of 10Vₚ₋ₚ, a pressure field of the resulting resonant mode forces the particles to its nodal planes, forming bands at least substantially perpendicular to the y-axis separated by 0.146 mm (i.e. half a wavelength at 5 MHz).

With the particles trapped relative to the y-axis, 5.25 MHz sinusoidal signals are again applied to the matched transducers, 212a and 212b, and the particles are moved to points separated by λ/2=0.139 mm in the x-direction. Therefore, a regular grid pattern resulting from the action of the levitation plate 210 and the two matched transducers, 212a and 212b, is formed. The traps contain single or multiple particles depending on the concentration thereof. The grid pattern can be seen in the top image in FIG. 11(b), in which 10 μm diameter polystyrene spheres were used as particles representative of biological particles such as red blood cells.

If At is increased from 0 to 2π the particles move up to a maximum distance of λ/2 =0.139 mm in the x-direction. FIG. 11(b) shows images of particles in a region of the cavity 208 for five different values of ΔΦ. When ΔΦ reaches 2π the particles have been moved to the position of the adjacent trap in the original nodal pattern. The process can be repeated to move the particles over greater distances. A negative change in ΔΦ produces movement in the opposite direction.

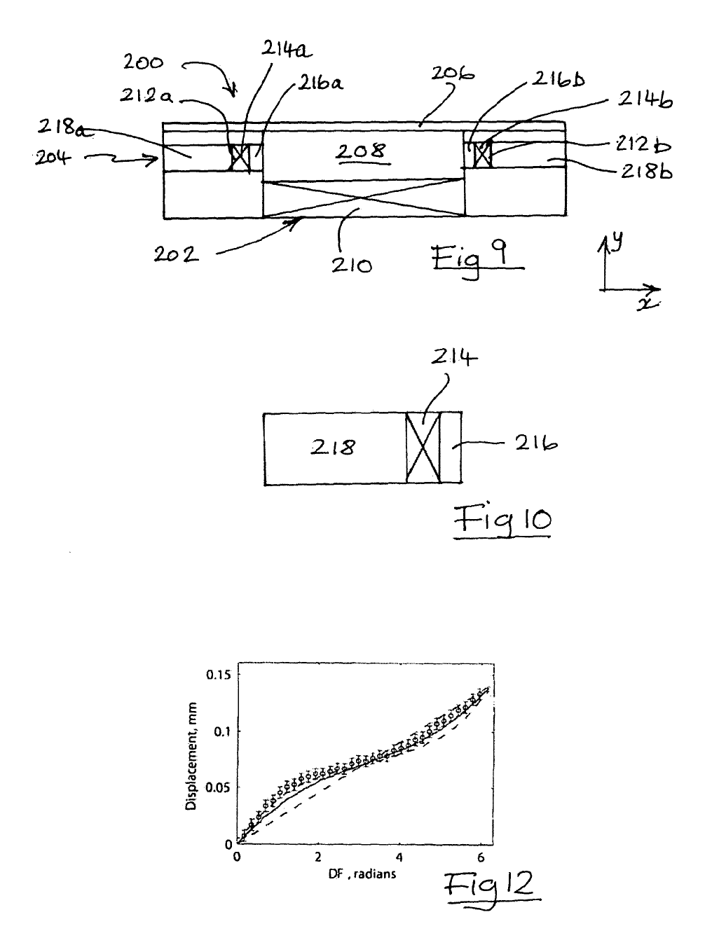

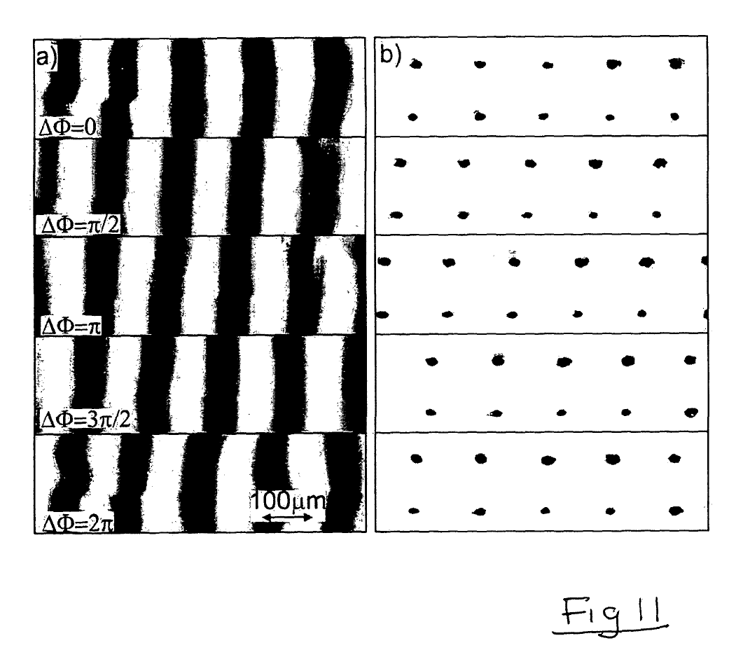

FIG. 12 is a graph of the result of an example in which a more extensive series of images was produced and used to measure the displacement of a specific group of particles as a function of ΔΦ, relative to an initial position when ΔΦ=0. In addition to the result, the position of the pressure field nodes predicted using the transmission line model is plotted. The behaviour of the particles is shown to be in agreement with the node positions predicted by the model with the small discrepancy attributed to the sensitivity of the transducer matching layer performance to the matching layer thickness and the material properties. The pressure amplitude of the standing wave generated is predicted by the model to be 300 kPa. Applying the analytical solution for a compressible sphere (assuming 10 μm polystyrene spheres in water) in a plane standing wave derived by Yosioka and Kawasima (“Acoustic radiation pressure on a compressible sphere,” Acustica 5, 167-173 (1995)) to this pressure gives a peak force of 50 pN.

The deviation from linearity between position and ΔΦ, seen in the graph of FIG. 12, is due to reflection on the surfaces of the transducers, 212a and 212b. The matched transducers, 212a and 212b, have a pressure reflection coefficient, R=0.21 (intensity reflection coefficient 0.04). The effect of non-zero reflection is to introduce a variation in the peak pressure amplitude as the phase is varied and an excursion from linearity. If P₀ is the maximum value of the pressure antinode amplitude for a given reflection coefficient then for R=0 the pressure antinode has the same amplitude, P₀, regardless of ΔΦ, but for R=0.21 the pressure antinode amplitude varies between 0.65 P₀ and P₀, as ΔΦ changes. For a hypothetical R=0.42, modelled by reducing the density used for the matching layer by 25%, but maintaining the same velocity, this variation is between 0.45 P₀ and P₀. The graph of FIG. 12 includes the expected node positions for the ideal R=0 (which gives a linear relation) and for R=0.42: an increase in the deviation from linearity with increased R can be seen.

Hence, standing waves with nodal positions determined by the relative phase, ΔΦ, between applied signals are generated and used to control the position of particles in a liquid medium.

Improvements and modifications may be incorporated herein without deviating from the scope of the invention.

1. An apparatus for manipulating particles, the apparatus comprising: an ultrasound source for providing a variable ultrasound signal within a region of interest; a controller connected to the ultrasound source such that it provides a control signal to the ultrasound source, wherein the variable ultrasound signal creates a pressure field within the region of interest, the shape and/or position of which can be altered by changing the control signal input to the ultrasound source such that a particle within the region of interest will move in response to changes in the pressure field.

2. (canceled)

3. The apparatus as claimed in claim 1, wherein the ultrasound source comprises a multi-element ultrasonic array.

4. The apparatus as claimed in claim 3, wherein the control signal implements electronic phasing or electronic amplitude changes of the multi-element array outputs.

5. The apparatus as claimed in claim 3, wherein the multi-element ultrasonic array comprises a plurality of transducers which are acoustically matched, acoustically damped, or electrically matched.

6. (canceled)

7. The apparatus as claimed in claim 3, wherein the multi-element array comprises particle levitation means operable to control movement of a particle in a substantially levitated state and particle manipulation means, operable to manipulate movement of a particle.

8. The apparatus as claimed in claim 7, wherein the particle manipulation means is operable to control the movement of a said particle in a substantially lateral direction.

9. The apparatus as claimed in claim 7, wherein the particle levitation means comprises one or more of the following: a piezoceramic plate and a reflection plate separated therefrom, and a pair of matched piezoelectric transducers separated from each other and disposed so as to face each other.

10. (canceled)

11. The apparatus as claimed in claim 9, wherein the pair of piezoelectric transducers, the piezoceramic plate and the reflection plate are arranged relative to each other so as to form a cavity wherein the boundaries of the cavity are provided by the piezoelectric transducers, the piezoceramic plate and the reflection plate.

12. The apparatus as claimed in claim 11, wherein the cavity comprises a fluid.

13. The apparatus as claimed in claim 12, wherein the fluid comprises water.

14. The apparatus as claimed in claim 1, comprising a plurality of matched piezoelectric transducers arranged to provide two-dimensional or three-dimensional control of a said particle.

15. The apparatus as claimed in claim 14, wherein, where a plurality of particles are present, at least one of said particles is moveable independently of the others.

16. (canceled)

17. The apparatus as claimed in claim 1, wherein the control signal changes the spectral frequency content of the ultrasound signal from the ultrasound source to thereby alter the shape and/or position of pressure field.

18.-20. (canceled)

21. The apparatus as claimed in claim 1, wherein the controller comprises computing means and an electronic signal generator wherein the computing means is provided with a computer program which operates an electronic controller which controls the ultrasound source.

22. A method for manipulating particles, the method comprising the steps of: providing an ultrasound source operable to provide a variable ultrasound signal within a region of interest; providing a control signal to the ultrasound source, wherein the variable ultrasound signal creates a pressure field within the region of interest, controlling the control signal input to thereby control the shape and/or position of the pressure field such that a particle within the region of interest is controllable.

23. (canceled)

24. The method as claimed in claim 22, wherein the ultrasound source comprises a multi-element ultrasonic array.

25. The method as claimed in claim 24, wherein the control signal implements electronic phasing of the multi-element array outputs.

26. The method as claimed in claim 24, wherein the multi-element ultrasonic array comprises a plurality of transducers which are acoustically matched, acoustically damped, or electrically matched.

27. (canceled)

28. The method as claimed in claim 24, wherein the multi-element array comprises particle levitation means operable to control movement of a particle in a substantially levitated state, and particle manipulation means, operable to manipulate movement of a particle, and the method further comprises actuating the particle levitation means to at least substantially levitate a particle, and actuating the particle manipulation means to manipulate the movement of a said particle.

29. The method as claimed in claim 28, wherein the particle manipulation means is operable to manipulate the movement of the said particle in a substantially lateral direction.

30. The method as claimed in claim 28, wherein the particle levitation means comprises one or more of the following: a piezoceramic plate and a reflection plate separated therefrom, and a pair of matched piezoelectric transducers separated from each other and disposed so as to face each other.

31. (canceled)

32. The method as claimed in claim 30, wherein the pair of piezoelectric transducers, the piezoceramic plate and the reflection plate are arranged relative to each other so as to form a cavity wherein the boundaries of the cavity are provided by the piezoelectric transducers, the piezoceramic plate and the reflection plate.

33. The method as claimed in claim 32, wherein the cavity is at least partially filled with fluid.

34. The method as claimed in claim 30, wherein the fluid comprises water.

35. The method as claimed in claim 26, wherein the ultrasound source comprises a plurality of matched piezoelectric transducers arranged to provide two-dimensional or three-dimensional control of a said particle.

36. The method as claimed in claim 35, wherein, where a plurality of particles are present, at least one of said particles is moveable independently of the others.

37. (canceled)

38. The method as claimed in claim 22, wherein controlling the control signal causes a change in the spectral frequency of the ultrasound signal from the ultrasound source to thereby alter the shape and/or position of pressure field.

39. The method as claimed in claim 24, wherein the control signal implements electronic amplitude changes of the multi-element array outputs.

40.-42. (canceled)

43. A controller for controlling the movement of particles, the controller being connectable to an ultrasound source to provide a variable ultrasound signal for creating a pressure field within a region of interest, and operable to control the ultrasound signal and thereby control the shape and/or position of the pressure field such that the movement of a particle within the region of interest is controlled.

44-45. (canceled)

46. The controller as claimed in claim 43, wherein the control signal changes the spectral frequency content of the ultrasound signal.

47. The controller as claimed in claim 43, adapted for use with an ultrasound source comprising a multi element ultrasonic array.

48. The controller as claimed in claim 47, wherein the control signal implements electronic phasing or electronic amplitude changes of the multi-element array outputs.

49.-50. (canceled)

51. The controller as claimed in claim 43 comprising computing means and an electronic signal generator wherein the computing means is provided with a computer program which operates an electronic controller for controlling the ultrasound source.

52. A micro-fluidic device comprising one or more fluid pathways wherein the device further comprises fluid manipulation means for moving a fluid along fluid pathways in the micro-fluidic device, the manipulation means comprising an ultrasound source for providing a variable ultrasound signal within the micro-fluidic device; a controller connected to the ultrasound source such that it provides a control signal to the ultrasound source, wherein the variable ultrasound signal creates a pressure field within the micro-fluidic device, the shape and/or position of which can be altered by changing the control signal input to the ultrasound source such that a fluid within the micro-fluidic device will move in response to changes in the pressure field.

53. The micro-fluidic device as claimed in claim 52, further comprising one or more fluid analysis locations.

54. The micro-fluidic device as claimed in claim 52, wherein the controller provides a control signal which causes the ultrasound source to create a predetermined pressure field in the region of interest.

55. The micro-fluidic device as claimed in claim 52, wherein the control signal can be altered to change the predetermined pressure field distribution in order to move one or more particle around the region of interest in a controlled manner.

56-57. (canceled)

58. The micro-fluidic device as claimed in claim 52, wherein the control signal changes the spectral frequency content of the ultrasound signal from the ultrasound source.

59. The micro-fluidic device as claimed in claim 52, wherein the ultrasound source is a multi element ultrasonic array.

60. The micro-fluidic device as claimed in claim 59, wherein the control signal implements electronic phasing or electronic amplitude changes of the multi-element array outputs.

61. (canceled)

62. The micro-fluidic device as claimed in claim 59, wherein the multi element ultrasonic array comprises a plurality of transducers which are acoustically matched.

63. (canceled)

64. A computer program product containing a set of instructions that, when executed, instruct a processor of an electronic device to implement the method of claim 22, wherein the electronic device includes, a processor and a computer-readable memory, said method comprising:
providing an ultrasound source operable to provide a variable ultrasound signal within a region of interest; providing a control signal to the ultrasound source, wherein the variable ultrasound signal creates a pressure field within the region of interest, controlling the control signal input to thereby control the shape and/or position of the pressure field such that a particle within the region of interest is controllable.
